(19) United States
(12) Patent Application Publication
(10) Pub. No.: US 2022/0226898 A1
(43) Pub. Date: Jul. 21, 2022

(54) METHOD FOR PRODUCING AN INDEXABLE INSERT AND A CUTTING TOOL

(71) Applicant: Guehring KG, Albstadt (DE)

(72) Inventors: Anja KREHN, Dietenhofen (DE); Andreas WEISS, Seukendorf (DE)

(73) Assignee: Guehring KG, Albstadt (DE)

(21) Appl. No.: 17/655,042

(22) Filed: Mar. 16, 2022

Related U.S. Application Data
(63) Continuation of application No. PCT/DE2020/100901, filed on Oct. 20, 2020.

(30) Foreign Application Priority Data
Oct. 25, 2019 (DE) 10 2019 128 929.7
Nov. 15, 2019 (DE) 10 2019 130 940.9

(51) Int. Cl. B22F 10/22; B22F 5/00; B22F 10/28; B33Y 70/10; B33Y 10/00; B33Y 80/00; B22F 3/24

(52) U.S. Cl. CPC B22F 10/22; B22F 5/00; B22F 10/28; B33Y 70/10; B33Y 10/00; B22F 2003/247; B22F 3/24; B22F 2005/001; B22F 2302/406; B22F 2302/10; B22F 2302/205; B33Y 80/00

(57) ABSTRACT

The invention relates to a method for producing an indexable insert comprising the following steps: a) providing a starting material for use in an additive manufacturing method in several layers of material; and b) bonding each layer of the starting material in the form of an indexable insert.

The invention relates to a method for producing an indexable insert and a cutting tool according to the respective independent claim.

The invention relates the technical field of indexable inserts. Indexable inserts serve the purpose of cutting metals or wood, for example.

Indexable inserts can be fastened in a tool holder, such as, e.g., a milling tool. Indexable inserts are available in various shapes and sizes, in order to be capable of being used in an application-specific manner. For example in the case of a milling tool, the milling head, to which the indexable inserts are firmly attached, is set into rotation for machining, and the rotating cutting edge is brought into contact with the workpiece to be treated.

The advantage with the use of indexable inserts comprising several blades is that the cutting insert can be rotated or turned and a new blade can thus be put to use as soon as a cutting edge wears and has become unusable, after releasing a clamping device. The rotated indexable insert can be used again repeatedly. Indexable inserts often have three or four blades, so that it can be rotated twice or three times, respectively, before it is replaced.

Due to the large variety of possible uses and the specific requirements on the geometry associated therewith, there is a need for a plurality of different indexable inserts. This is problematic in particular with regard to the storage of replacement parts because a corresponding plurality of different indexable inserts has to be kept ready, in order to provide them quickly on the market.

DE 10 2016 108 507 A1 is further known from the prior art.

The invention has thus taken on the object of providing a method for producing an indexable insert and an indexable insert made of a material for the sinter-based and/or melt-based additive manufacture, which overcome the disadvantages in the prior art and which in particular ensure a quick provision of a wide variety of indexable inserts as replacement parts in an economically advantageous manner.

This object is solved by means of a method for producing an indexable insert and an indexable insert made of a material for the sinter-based and/or melt-based additive manufacture according to the respective independent claim. The subject matter of the dependent claims relates to advantageous designs.

The invention comprises a method for producing an indexable insert, comprising the following steps:
a) providing a starting material for use in an additive manufacturing method in several layers of material; and
b) bonding each layer of material of the starting material in the form of an indexable insert.

Due to the provision of the starting material for the additive manufacture and of the forming of an indexable insert when connecting the layers of material, the advantage results that the provision of the wide variety of indexable inserts is ensured in particular as replacement parts in an economically advantageous manner.

According to an advantageous aspect, the provision of the starting material for use in the additive manufacturing method in several layers of material comprises the provision of powdery or molten starting material. The powdery material can be solidified in a separate step. The molten starting material can be bonded solely by means of cool-down.

The provision of the starting material for use in the additive manufacturing method in several layers of material preferably comprises the provision of starting material in a carrier material. The carrier material can advantageously be removed subsequently.

The provision of the starting material for use in the additive manufacturing method in several layers of material further preferably comprises the provision of starting material from a group of hard metal, solid carbide, polycrystalline cubic boron nitride (CBN), polycrystalline diamond (PCD), or combinations thereof.

The starting material is advantageously bonded in several layers of material in the form of an indexable insert in a for use in a sinter-based and/or melt-based additive manufacturing method. The layers of material can thereby have an identical or different form. In particular the following may be considered as additive manufacturing methods: laser sintering (SLS), stereolithography (SLA), polygraphy, fused deposition modeling (FDM), selective laser melting (SLM), and 3D printing (3DP). These methods are generally suitable to apply the advantages of the additive manufacture in the area of the indexable inserts.

The provision of a starting material for use in an additive manufacturing method further advantageously takes place in several layers of material.

It is particularly preferred when each layer of material is provided in the form of an indexable insert.

Particularly advantageously, at least two layers of material are provided in a different form. The different form also comprises a different thickness of the individual layers of material.

What is also advantageous is the arrangement of the layers of material in such a way that a chip guiding groove is created, which can influence the movement of the chips. The design of the chip guiding groove is variable thereby.

According to the previous advantageous aspect, the chip guiding groove comprises a section running inwards and a section running outwards. The chip guiding groove can preferably be designed in the manner of a (curved) concave contour, which extends over a portion or the entire side surface of the indexable insert.

According to a further advantageous aspect, the indexable insert can comprise contour sections on the top side or the bottom side. Contour sections of this type, which connect on the top, can be formed, for example, so as to slope towards the middle of the indexable insert in the manner of wave breakers (chip breakers) and can in particular comprise depressions.

The layers of material are advantageously applied in the region of the edge of the indexable insert with a height and width in the range of 0.01 mm to 0.1 mm.

It is particularly preferred when at least one corner comprises a recess. The recesses is preferably molded so as to receive angular (triangular or quadrangular) cutting elements (made of PCD, CBN) therein. According to the method, it can be provided thereby that the cutting elements are soldered in separately or are (co-) produced in the additive production process.

According to another advantageous aspect, the provision of the starting material for use in the additive manufacturing method in several layers of material comprises the provision of at least two different starting materials. The different starting materials can be replaced in sections or alternately.

According to an advantageous aspect, for bonding each layer of material, the starting material is heated up by a predetermined temperature in order to solidify the starting material. The predetermined temperature can be selected in such a way so as to change the inner structure or the phase state of the starting material.

Moreover, it is preferred when an adhesive is used to bond each layer of material of the starting material. The adhesive can comprise several components.

After the provision of the starting material in several layers of material, method step b) is advantageously performed after a respective provided layer of material.

Moreover, it is advantageous when the method further comprises the method step of grinding of the indexable insert. The grinding can be a regrinding or a multi-stage sharpening of the cutting edges.

It is preferred when the method comprises the method step of edge rounding of the indexable insert with a minimum radius. Due to the rounding, the service life of the blades (main blade) can be extended.

The method advantageously comprises the method step of abrasive blasting of the edges, whereby the hardness and strength thereof can be improved and/or a deburring can be performed.

Moreover, it is advantageous when the method comprises the method step of heat treatment of the indexable insert. The heat treatment can be used to harden (changing of the inner structure) of the material.

Moreover, it is advantageous when the method comprises the method step of coating of the indexable insert with a hard substance, in particular with a tribological hard substance.

Another aspect of the invention relates to a cutting tool comprising an indexable insert, which is produced by means of the above method. A drill is one example for a cutting tool.

The invention will be described below on the basis of the example illustrated in the drawings, in which:

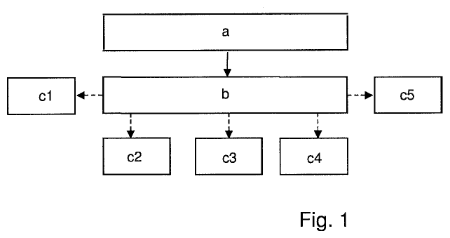

FIG. 1 shows a block diagram for a method for producing an indexable insert according to an exemplary embodiment of the invention;

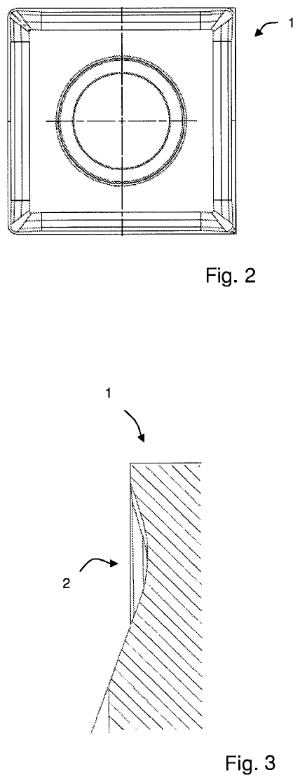

FIG. 2 shows a top view onto an indexable insert comprising a chip guiding groove according to an exemplary embodiment of the invention;

FIG. 3 shows a sectional view onto the indexable insert from FIG. 2; and

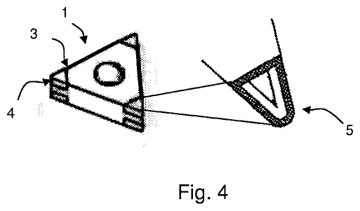

FIG. 4 shows a sectional view onto an indexable insert comprising recess and cutting elements arranged therein.

A method for producing an indexable insert is illustrated in an exemplary manner in FIG. 1.

In the method according to the invention, the starting material is provided during a sinter-based and/or melt-based additive manufacture to form an indexable insert, so that a large variety of indexable inserts can be provided in an economically advantageous manner.

In the first step, a starting material is provided thereby for use in an additive manufacturing method in several layers of material. (step a).

In alternatives, the starting material can be provided in a powdery or molten manner in this step (step a). It is also possible to provide the starting material in a carrier material. The starting material can be from a group of hard metal, solid carbide, polycrystalline cubic boron nitride (CBN), polycrystalline diamond (PCD), or combinations thereof.

For example, each layer of material of the starting material can be provided in the form of an indexable insert, or at least two layers of material in a different form.

Moreover, at least two different starting materials can be provided.

A bonding of each layer of material of the starting material in the form of an indexable insert takes place in the subsequent step (step b).

In an alternative, the layer of material of the starting material is heated up by a predetermined temperature, in order to solidify the starting material.

In a further alternative, an adhesive is used to bond each layer of material of the starting material.

It is possible thereby that after the provision of the starting material in several layers of material, method step b) is performed after a respective provided layer of material. This can be repeated multiple times.

In one alternative, it is provided that the method further comprises the method step of grinding of the indexable insert. (step c1)

In one alternative, it is provided that the method further comprises the method step of edge rounding of the indexable insert. (step c2)

In one alternative, it is provided that the method further comprises the method step of abrasive blasting of the edges of the indexable insert. (step c3)

In one alternative, it is provided that the method further comprises the method step of heat treatment of the indexable insert. (step c4)

In one alternative, it is provided that the method further comprises the method step of coating of the indexable insert with a hard substance, in particular with a tribological hard substance. (step c5).

An exemplary embodiment of an indexable insert 1 is shown in a top view in FIG. 2. Along the outer contour, the indexable insert 1 comprises a chip guiding groove 2, along which a removed chip is guided and broken. The chip guiding groove 2 is formed in a curved or concave manner, respectively, for this purpose.

A sectional view of the indexable cutting plate 1 from FIG. 2 is illustrated in FIG. 3. According to an advantageous example, the curvature of the chip guiding groove 2 along the side wall is formed here over the entire side surface of the indexable insert 1.

A further example for an indexable insert 1 comprising contour section 5 on the top side in the manner of a chip breaker is shown in FIG. 4. A top side thereby comprises a circumferential elevated contour section 5, the middle of which is lowered, in order to guide the resulting chip in the manner of a wave breaker, and to break it thereby.

In the shown example, the indexable insert 1 in each case comprises a triangular recess 4 on each corner and on top side and bottom side. Triangular cutting elements (PCD, CBN) are to be received so as to be arranged in the recess 4. According to the method, it can be provided thereby that the indexable inserts are soldered in separately or are formed in the additive production process in a corresponding method step.

1. A method for producing an indexable insert, comprising:
a) providing a starting material for use in an additive manufacturing method in several layers of material; and
b) bonding each layer of material of the starting material in the form of an indexable insert.

2. The method according to claim 1, wherein said providing a starting material for use in an additive manufacturing method in several layers of material comprises providing powdery or molten starting material.

3. The method according to claim 1, wherein said providing a starting material for use in an additive manufacturing method in several layers of material comprises providing the starting material in a carrier material.

4. The method according to claim 1, wherein said providing a starting material for use in an additive manufacturing method in several layers of material comprises providing the starting material from a group of hard metal, solid carbide, polycrystalline cubic boron nitride (CBN), polycrystalline diamond (PCD), or combinations thereof.

5. The method according to claim 1, wherein the starting material is bonded in several layers of material in the form of an indexable insert for use in a sinter-based and/or melt-based additive manufacturing method.

6. The method according to claim 1, wherein said providing a starting material for use in an additive manufacturing method takes place in several layers of material.

7. The method according to claim 6, wherein each layer of material is provided in the form of an indexable insert.

8. The method according to claim 6, wherein at least two layers of material are provided in a different form.

9. The method according to claim 6, wherein the layers of material are arranged in such a way that a chip guiding groove is created.

10. The method according to claim 9, wherein the chip guiding groove comprises a section running inwards and a section running outwards.

11. The method according to claim 6, wherein a corner comprises at least one recess.

12. The method according to claim 6, wherein the layers of material are arranged in such a way that the indexable insert comprises contour sections on the top side or the bottom side.

13. The method according to claim 6, wherein the layers of material are applied in a region of an edge of the indexable insert with a height and width in the range of 0.01 mm to 0.1 mm.

14. The method according to claim 1, wherein said providing a starting material for use in an additive manufacturing method in several layers of material comprises providing at least two different starting materials.

15. The method according to claim 1, wherein for bonding each layer of material, the starting material is heated up by a predetermined temperature in order to solidify the starting material.

16. The method according to claim 1, wherein an adhesive is used to bond each layer of material of the starting material.

17. The method according to claim 1, wherein after said providing a starting material in several layers of material, said bonding is performed after a respective provided layer of material.

18. The method according to claim 1, wherein the method further comprises grinding the indexable insert.

19. The method according to claim 1, wherein the method further comprises edge rounding the indexable insert with a minimum radius.

20. The method according to claim 1, wherein the method further comprises abrasive blasting the edges of the indexable insert.

21. The method according to claim 1, wherein the method further comprises heat treatment of the indexable insert.

22. The method according to claim 1, wherein the method further comprises coating the indexable insert with a hard substance.

23. A cutting tool comprising an indexable insert, which is produced by a method according to claim 1.

24. The method according to claim 1, wherein the method further comprises coating the indexable insert with a tribological hard substance.
